(19) United States
(12) Patent Application Publication
(10) Pub. No.: US 2010/0217643 A1
(43) Pub. Date: Aug. 26, 2010

(54) Mass Request Organization System

(76) Inventor: John J. Legath, Johnstown, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/713,691

(22) Filed: Feb. 26, 2010

Related U.S. Application Data
(60) Provisional application No. 61/155,743, filed on Feb. 26, 2009.

(51) Int. Cl. G06Q 50/00; G06Q 10/00; G06F 17/30; G06Q 20/00

(52) U.S. Cl. 705/8; 705/30; 707/769

(57) ABSTRACT

A computer-implemented method for receiving and fulfilling special intention Mass requests includes receiving at a central processing system a request for a special intention Mass and stipend payment from a requester. The request includes at least one request criterion. A database of the central processing system is then searched for an available Mass that meets the at least one request criterion. A confirmation inquiry message is transmitted from the central processing system to a Church to confirm a date and availability of the available Mass. A confirmation response message from the Church confirming the date and availability of the available Mass is received at the central processing system. The stipend payment from the central processing system is transmitted to the Church. A confirmation and a Mass Card is transmitted from the central processing system to the requester and the Church.

### CROSS-REFERENCE TO RELATED APPLICATIONS

The present application claims priority from U.S. Provisional Patent Application No. 61/155,743, filed Feb. 26, 2009, which is incorporated herein by reference in its entirety.

### STATEMENT UNDER 37 C.F.R. §1.71(e)

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND OF THE INVENTION

1. Field of the Invention

The present invention relates to a Mass Request Organization System for requesting the performance of a special intention Mass via the Internet. More specifically, the present invention relates to a Mass Request Organization System for processing requests for the performance of special intention Masses through a dedicated clearinghouse that receives requests and payment from a consumer via the Internet and then confirms available Mass dates with a church and forwards the stipend payments. After confirmation by the parish priest or authorized parish representative, the clearinghouse forwards the confirmation along with a Mass Card to the requesting consumer.

2. Description of Related Art

The Holy Mass is the heart and soul of the Catholic Church's worship. As such, Mass is not just offered for the benefit of the priest, but for all the faithful, both living and deceased, and in a special manner for those whom the Celebrant commemorates the Mass.

The origin of the stipend, or Mass offering, dates back to the early days of the Catholic Church. Initially, the offerings were in the form of alms, which were distributed to the needy, while a portion was given to the priest. Around the time of the Eighth Century, alms were replaced with money and the practice of stipends for priests became an acceptable practice within the Church. By the Sixteenth Century, the practice of requesting Masses for special intentions became so popular that the Church introduced guidelines under the Code of Canon Law in order to prevent any mismanagement of the stipends. The canons are in effect today, including the amount of stipend that could be offered and accepted by the priest.

Priests receive 100% of the Mass stipends in support of their work in all aspects of the parish community. Any notion of buying and selling Masses or trafficking in the sale of Masses is prohibited by the Catholic Church under the strict guidelines of the Church's Code of Canon Law.

A parishioner, or any consumer or donor who may have a spouse, family member, relative, friend or acquaintance whom they would like to honor with a special intention Mass, can do so by simply contacting the parish office of any Catholic church they choose. Today, the customary process is to initiate the request in person, but it can be done over the telephone or through the mail All requests are based on availability and the parish is required to keep accurate records in a special Mass book. In this respect, not much has changed since the Sixteenth Century regarding special intention Mass requests. The parish secretary is generally the first point of contact. The secretary can give an update on the availability of Masses up to one year in advance. Beyond one year the request must be declined, postponed, or the Pastor, under the Code of Canon Law, can transfer the request to another parish.

Some parishes have begun to accept Mass requests via the Internet; however, this has been done only on a limited basis by a handful of parishes and missionaries. Currently, many churches have not yet taken full advantage of all the capabilities and conveniences offered by modern telecommunications, especially the Internet.

Accordingly, there is a general need for a worldwide clearinghouse, or centralized processing center for Mass requests that utilizes the Internet and toll-free phone services that allow consumers or donors from across the globe to easily and efficiently place requests to have special intention Masses performed at a particular church, or in a particular geographic area, or to facilitate the efficient transfer of requests from one church to another when the first church has no available Mass dates. It is also desirable to do so without disrupting the current record keeping practices of parishes and in keeping with the Church's Code of Canon Law.

### SUMMARY OF THE INVENTION

It is an object of the present invention to provide a centralized system for processing requests by consumers and donors to have special intention Masses celebrated at a particular church, or in a particular geographic location.

It is an object of the present invention to provide such a centralized system that allows a consumer or donor to make such requests from a home or personal computer by accessing a service via the Internet or toll-free telephone service.

It is an object of the present invention to provide a quicker and more efficient system for having special intention Mass requests fulfilled in a timely manner.

It is an object of the present invention to provide a system for having special intention Mass requests fulfilled in a particular location, while the requester is located at a remote location.

It is an object of the present invention to provide a system for processing requests to have a special intention Mass celebrated that assists small and medium-sized churches, as well as missionaries, in filling their calendars with special intention Masses.

It is an object of the present invention to provide a system for permitting a consumer or donor requesting that a special intention Mass be celebrated in at least one of a plurality of locations.

According to an embodiment of the present invention a computer-implemented method for receiving and fulfilling special intention Mass requests is provided. The method includes the steps of: receiving at a central processing system a request for a special intention Mass and stipend payment from a requester, wherein the request includes at least one request criterion; searching a database of the central processing system for an available Mass that meets the at least one request criterion; transmitting a confirmation inquiry message from the central processing system to a Church to confirm a date and availability of the available Mass; receiving at the central processing system a confirmation response message from the Church confirming the date and availability of the available Mass; transmitting the stipend payment from the central processing system to the Church; and transmitting a confirmation and a Mass Card from the central processing system to the requester and the Church.

The at least one request criterion may include a specific Church, a locality of the Church, a geographic area of the Church, or a date for fulfilling the special intention Mass request. Additionally, the Church may be a Mission.

According to a further aspect of the present invention, the method may further include the steps of: recording and storing in the database each request received by the central processing system and each Church to which each request was forwarded; generating at the central processing system an audit report for an individual Church identifying the requests forwarded to the individual Church; and transmitting the audit report from the central processing system to the Church. Prior to the generating step, generation of the audit report for the individual Church may be scheduled at regular intervals at the central processing system. Alternatively, prior to the generating step, a request for generation of the audit report from a Church is received at the central processing system.

According to a still further aspect of the present invention, the step of searching the database of the central processing system for the available Mass includes the steps of: determining if a Mass that meets the at least one request criterion is listed as available in the database of the central processing system; if a Mass that meets the at least one request criterion is listed as available in the database, identifying the available Mass and proceeding to the step of transmitting a confirmation inquiry message from the central processing system to the Church; if a Mass that meets the at least one request criterion is not listed as available in the database, transmitting from the central processing system an inquiry to the requester to expand the at least one request criterion; receiving at the central processing system a response from the requester to the inquiry to expand the at least one request criterion; and if the requester chooses to expand the at least one request criterion, repeating the above steps for a Mass that meets the at least one expanded request criterion.

According to yet another aspect of the present invention, the at least one request criterion specifies a particular Church and the inquiry to the requester to expand the at least one request criterion includes an inquiry to alternatively have the request placed on a waiting list of the particular Church. The method further includes the steps of: receiving at the central processing system a response from the requester to the inquiry to alternatively have the request placed on a waiting list of the particular Church; and if the requester chooses to have the request placed on the waiting list of the particular Church, transmitting a message from the central processing system to the particular Church to have the request placed on the waiting list.

According to yet another aspect of the present invention, the at least one request criterion specifies a particular geographic area that includes a plurality of Churches and the inquiry to the requester to expand the at least one request criterion includes an inquiry to alternatively have the request placed on a waiting list of a Church within the particular geographic area having a shortest waiting list. The method further includes the steps of: receiving at the central processing system a response from the requester to the inquiry to alternatively have the request placed on the waiting list of the Church within the particular geographic area having the shortest waiting list; if the requester chooses to have the request placed on the waiting list of the Church within the particular geographic area having the shortest waiting list, identifying the Church of the plurality of Churches within the particular geographic area having the shortest waiting list; and transmitting a message from the central processing system to the Church of the plurality of Churches within the particular geographic area having the shortest waiting list to have the request placed on the shortest waiting list.

According to yet another aspect of the present invention, the at least one request criterion specifies a particular geographic area that includes a plurality of Churches and the inquiry to the requester to expand the at least one request criterion includes an inquiry to alternatively have the request fulfilled by a Mission. The method further includes the step of: if the requester chooses to have the request fulfilled by a Mission, identifying a Mission and proceeding to the step of transmitting the confirmation inquiry message from the central processing system to the Mission.

Further details and advantages of the invention will become clear upon reading the following detailed description in conjunction with the accompanying drawing figures, wherein like parts are designated with like reference numerals throughout.

### BRIEF DESCRIPTION OF THE DRAWINGS

FIG. 1 is a schematic representation of a special intention Mass Request Organization System according to an embodiment of the present invention.

FIG. 2 is a schematic representation of a process for requesting and confirming special intention Masses via a special intention Mass Request System according to an embodiment of the present invention.

FIG. 3 is a schematic representation of a process providing a donor or consumer with options as to where the requested special intention Mass may be celebrated according to a further embodiment of the present invention.

### DETAILED DESCRIPTION OF THE INVENTION

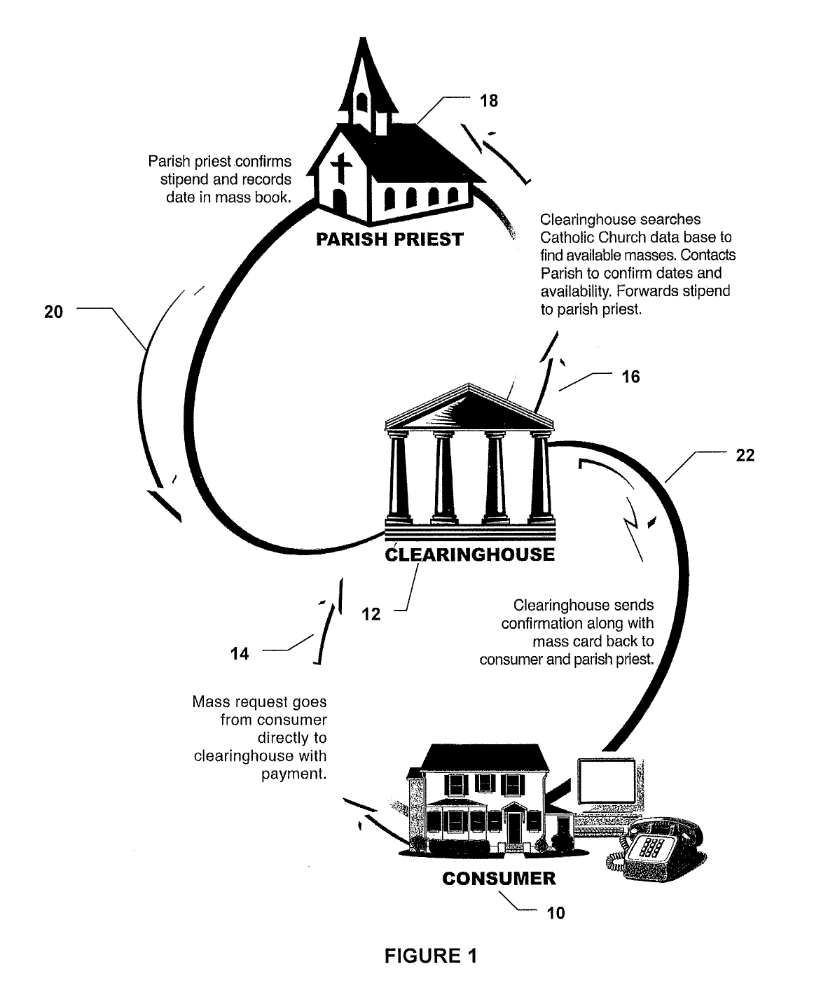

FIG. 1 shows a schematic representation of a four-step automated special intention Mass Request System according to an embodiment of the present invention. The system allows for a consumer or donor to request that a special intention Mass be celebrated at a particular location or within a particular geographic area, without the need to directly contact or visit the church or parish priest. The system provides a clearinghouse that will facilitate the process of receiving and fulfilling special intention Mass requests.

With reference to FIG. 1, the system includes a requester 10, such as a consumer or donor, accessing a website or URL of the clearinghouse 12 via a home or personal computer connected to the Internet through a telephone modem, high-speed or other suitable connection. Alternatively, the requester 10 may dial a toll-free telephone service to place his/her request 14. The requester 10 places a Mass request 14 directly with the clearinghouse 12 by accessing the clearinghouse's 12 website or phone service and transmitting the request 14 along with payment information to the clearinghouse 12.

With further reference to FIG. 1, the clearinghouse 12 may then access a Church database 16 to search for available Masses at the church identified by the requester 10, or for available Masses at churches within a particular geographic area and/or Masses that are being observed on a specific date identified by the requester 10. When an available Mass date is identified in the database 16 according to the requester's 10 requested criteria, the clearinghouse 12 contacts the parish priest or authorized parish representative 18 to confirm the dates and availability of a particular Mass scheduled to be celebrated at the church. After receipt 20 of confirmation, the clearinghouse 12 will forward the stipend payment provided by the requester 10 to the parish priest or authorized parish representative 18. Interaction between the clearinghouse 12 and the parish priest or authorized parish representative 18 may be conducted via any suitable method and is not limited to communications conducted via a website or over the Internet. For instance, an e-mail may be sent to the parish priest or authorized parish representative 18 asking to confirm availability, or a customer service representative may call the parish priest or authorized parish representative 18 to confirm the availability of a scheduled Mass.

After receiving the stipend payment, the parish priest or authorized parish representative 18 will confirm receipt 20 of the stipend payment with the clearinghouse 12 and record the date of the special intention Mass celebration within the church's Mass book. The clearinghouse 12 will then forward the confirmation 22 along with a Mass Card back to the requesting requester 10 and to the parish priest or authorized parish representative 18.

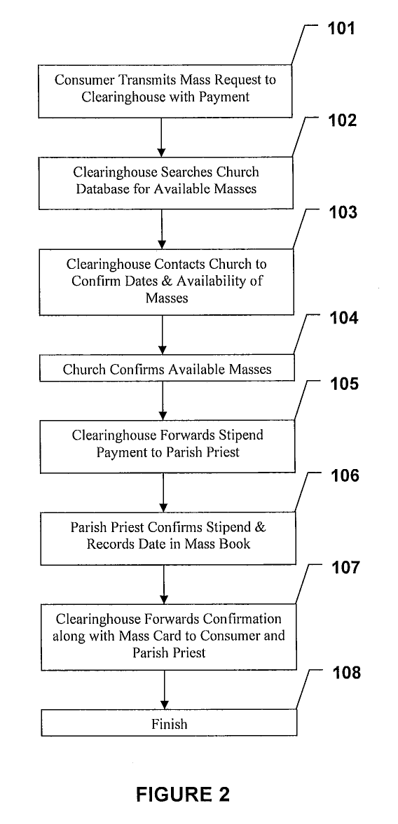

With reference to FIG. 2, a flow diagram illustrating the process for requesting and confirming special intention Masses via a special intention Mass Request System according to an embodiment of the present invention is shown. The process begins at Step 101 with the requester accessing the clearinghouse and transmitting a request that a special intention Mass be celebrated along with the stipend payment. This step also encompasses the identification of a particular church or a particular geographic area where the requester would like the special intention Mass to be celebrated. At Step 102 the clearinghouse will search the church database for available scheduled Masses at a particular church or within a particular geographic location according to the church or area identified by the requester and determine if any such Masses are available. When an available Mass is identified within the database, the clearinghouse contacts the parish priest or authorized parish representative to confirm the dates and availability of the identified scheduled Mass (Step 103).

After the parish priest or authorized parish representative confirms the availability of the identified scheduled Mass (Step 104), the clearinghouse forwards the stipend payment provided by the requester to the parish priest or authorized parish representative (Step 105). At Step 106 the parish priest or authorized parish representative confirms receipt of the stipend with the clearinghouse and records the date within the church's Mass book. The clearinghouse then forwards this confirmation along with a Mass Card to the requester and to the parish priest or authorized parish representative (Step 107). Such confirmation will show separately the stipend paid to the parish priest. The requesting process is then finished and the special intention Mass is celebrated according to the scheduled date (Step 108).

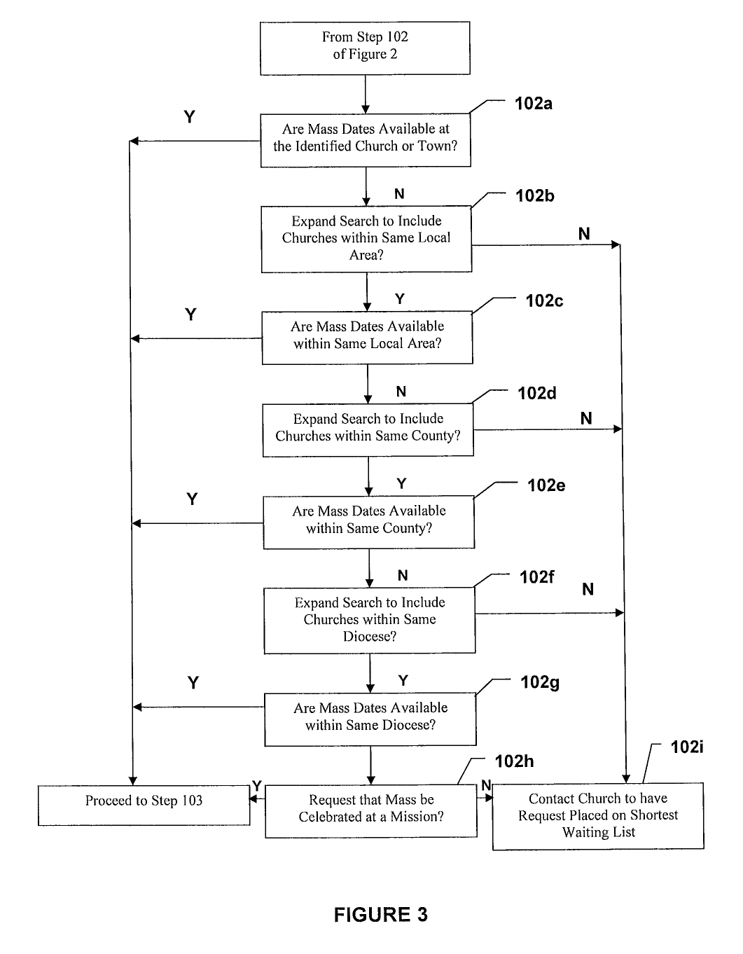

With reference to FIG. 3, in a further embodiment of the present invention, upon receipt of a request by a requester via the clearinghouse website (Step 101 in FIG. 2), the clearinghouse will search the church database for available Mass dates at the specific church or geographic area identified by the requester (Step 102 in FIG. 2). For instance, the requester may ask that the Mass be celebrated at a particular church or within a certain town because family and/or friends live in the area or attend services at that particular church. The database will then check for available Mass dates at that church or in that town (Step 102a). If none are available, the website will give the requester the option of reserving a place on the waiting list of the requested church or expanding the search to include other churches within the same local area as the requested church (Step 102b). The clearinghouse will then search the church database to locate available Mass dates within the local area (Step 102c).

If no available Masses are found within the requested local area, then the clearinghouse will ask the requester if the requester would like to expand the search to the surrounding county or reserve a place on the shortest waiting list within the identified local area (Step 102d). The clearinghouse will then search the church database to locate available Mass dates within the county (Step 102e). If no available Masses are found within the requested county, then the clearinghouse will ask if the requester would like to expand the search to the surrounding Diocese, or reserve a place on the shortest waiting list within the identified county (Step 102f). The clearinghouse will then search the church database to locate available Mass dates within the Diocese (Step 102g). Finally, if no available Masses found within the requested Diocese are available, the website will ask the requester if the requester would like to be placed on the shortest waiting list in the region or Diocese or request that the special intention Mass be celebrated at a Mission (Step 102h).

Whenever an available Mass date is found that fits within the requester's search criteria, the clearinghouse will proceed to contact the Parish to confirm the dates and availability of Masses (Step 103) and continue with the process illustrated in FIG. 2. If the requester decides, at any time, to be placed on a waiting list, the clearinghouse will contact the church with the shortest waiting list within the area identified by the requester to have the requester placed on that church's waiting list (Step 102i).

In this manner, requests for special intention Masses to be celebrated and the accompanying stipend payments can be funneled or transferred to smaller or medium-sized parishes having open dates on the Mass calendar or can be transferred to Missions so as to provide an important source of donor stipend payments to such small churches and Missions.

According to another aspect of the present invention, the Mass requests received by the clearinghouse 12 as well as the date, the Church and the name of the Parish Priest performing the Mass as per the special intention request are recorded and tracked by the clearinghouse 12 through the use of an automated system, such as a suitably configured computer. Audit reports may then be generated by the system from time to time for each individual Church, Parish Priest and/or Diocese for the Mass requests received by the clearinghouse and forwarded to the Church, Parish Priest or any of the Churches within a certain Diocese for the performance of a special intention Mass. The audit reports may then be automatically transmitted by the clearinghouse 12 to the Church, Parish Priest and/or Diocese so that the internal records of the Church, Parish Priest and/or Diocese may be checked and any outstanding unfulfilled special intention Masses may be performed or forwarded to another Church or to a Mission. Alternatively, the audits may be performed and the reports forwarded upon request of the Church, Parish Priest and/or Diocese. This auditing capability may also be utilized by Missions. Additionally, the present invention also allows for a Church, Parish Priest and/or Diocese to quickly and easily forward unfulfilled requests to another Church or a Mission.

The methods and systems described herein may be deployed in part or in whole through a machine that executes computer software program codes, and/or instructions on a processor. The processor may be part of a server, client, network infrastructure, mobile computing platform, stationary computing platform, or other computing platform. The processor may be communicatively connected to the Internet or any other distributed communications network via a wired or wireless interface. The processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application-specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executed on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While specific embodiments of the invention have been described in detail, it will be appreciated by those skilled in the art that various modifications and alternatives to those details could be developed in light of the overall teachings of the disclosure.

The invention claimed is:

1: A computer-implemented method for receiving and fulfilling special intention Mass requests, the method comprising the steps of:
a) receiving at a central processing system a request for a special intention Mass and stipend payment from a requester, wherein the request includes at least one request criterion;
b) searching a database of the central processing system for an available Mass that meets the at least one request criterion;
c) transmitting a confirmation inquiry message from the central processing system to a Church to confirm a date and availability of the available Mass;
d) receiving at the central processing system a confirmation response message from the Church confirming the date and availability of the available Mass;
e) transmitting the stipend payment from the central processing system to the Church; and
f) transmitting a confirmation and a Mass Card from the central processing system to the requester and the Church.

2: The computer-implemented method for receiving and fulfilling special intention Mass requests of claim 1, wherein the at least one request criterion includes a specific Church.

3: The computer-implemented method for receiving and fulfilling special intention Mass requests of claim 1, wherein the at least one request criterion includes a locality of the Church.

4: The computer-implemented method for receiving and fulfilling special intention Mass requests of claim 1, wherein the at least one request criterion includes a geographic area of the Church.

5: The computer-implemented method for receiving and fulfilling special intention Mass requests of claim 1, wherein the at least one request criterion includes a date for fulfilling the special intention Mass request.

6: The computer-implemented method for receiving and fulfilling special intention Mass requests of claim 1, wherein the Church is a Mission.

7: The computer-implemented method for receiving and fulfilling special intention Mass requests of claim 1, further comprising the steps of:
g) recording and storing in the database each request received by the central processing system and each Church to which each request was forwarded;
h) generating at the central processing system an audit report for an individual Church identifying the requests forwarded to the individual Church; and
i) transmitting the audit report from the central processing system to the Church.

8: The computer-implemented method for receiving and fulfilling special intention Mass requests of claim 7, further comprising the step of:
prior to the generating step, scheduling at the central processing system the generation of the audit report for the individual Church at regular intervals.

9: The computer-implemented method for receiving and fulfilling special intention Mass requests of claim 7, further comprising the step of:
prior to the generating step, receiving at the central processing system a request for generation of the audit report from a Church.

10: The computer-implemented method for receiving and fulfilling special intention Mass requests of claim 1, wherein the step of searching the database of the central processing system for the available Mass comprises the steps of
b1) determining if a Mass that meets at the least one request criterion is listed as available in the database of the central processing system;
b2) if a Mass that meets the at least one request criterion is listed as available in the database, identifying the available Mass and proceeding to the step of transmitting the confirmation inquiry message from the central processing system to the Church;
b3) if a Mass that meets the at least one request criterion is not listed as available in the database, transmitting from the central processing system an inquiry to the requester to expand the at least one request criterion;
b4) receiving at the central processing system a response from the requester to the inquiry to expand the at least one request criterion; and
b5) if the requester chooses to expand the at least one request criterion, repeating steps (b1)-(b4) for a Mass that meets the at least one expanded request criterion.

11: The computer-implemented method for receiving and fulfilling special intention Mass requests of claim 10, wherein the at least one request criterion specifies a particular Church and the inquiry to the requester to expand the at least one request criterion includes an inquiry to alternatively have the request placed on a waiting list of the particular Church, further including the steps of:
receiving at the central processing system a response from the requester to the inquiry to alternatively have the request placed on a waiting list of the particular Church; and
if the requester chooses to have the request placed on the waiting list of the particular Church, transmitting a message from the central processing system to the particular Church to have the request placed on the waiting list.

12: The computer-implemented method for receiving and fulfilling special intention Mass requests of claim 10, wherein the at least one request criterion specifies a particular geographic area that includes a plurality of Churches and the inquiry to the requester to expand the at least one request criterion includes an inquiry to alternatively have the request placed on a waiting list of a Church within the particular geographic area having a shortest waiting list, further including the steps of:
receiving at the central processing system a response from the requester to the inquiry to alternatively have the request placed on the waiting list of the Church within the particular geographic area having the shortest waiting list;
if the requester chooses to have the request placed on the waiting list of the Church within the particular geographic area having the shortest waiting list, identifying the Church of the plurality of Churches within the particular geographic area having the shortest waiting list; and
transmitting a message from the central processing system to the Church of the plurality of Churches within the particular geographic area having the shortest waiting list to have the request placed on the shortest waiting list.

13: The computer-implemented method for receiving and fulfilling special intention Mass requests of claim 10, wherein the at least one request criterion specifies a particular geographic area that includes a plurality of Churches and the inquiry to the requester to expand the at least one request criterion includes an inquiry to alternatively have the request fulfilled by a Mission, further including the step of:
if the requester chooses to have the request fulfilled by a Mission, identifying a Mission and proceeding to the step of transmitting the confirmation inquiry message from the central processing system to the Mission.
